(19) United States
(12) Patent Application Publication
(10) Pub. No.: US 2010/0057895 A1
(43) Pub. Date: Mar. 4, 2010

(54) Methods of Providing Reputation Information with an Address and Related Devices and Computer Program Products

(75) Inventor: Yuming Huang, Aurora, IL (US)

Correspondence Address: AT&T Legal Department - MB;Attn: Patent Docketing, Room 2A-207, One AT&T Way, Bedminster, NJ, 07921, US

(73) Assignee: AT& T INTELLECTUAL PROPERTY I, L.P.

(21) Appl. No.: 12/201,032

(22) Filed: Aug. 29, 2008

(51) Int. Cl. G06F 15/177

(52) U.S. Cl. 709/222

(57) ABSTRACT

Methods of providing reputation information for a remote device may include receiving a name for the remote device from a client device. Responsive to receiving the name for the remote device, the name may be translated into an Internet Protocol (IP) address for the remote device, and reputation information may be provided for the remote device. The IP address and the reputation information may be transmitted to the client device, for example, in one IP packet.

### FIELD OF THE INVENTION

The present invention relates to the field of communications, and more particularly to network communications and related devices and computer program products.

### BACKGROUND

Phishing is a criminally fraudulent attempt to acquire sensitive information such as usernames, passwords, and credit card or bank account details by masquerading as a trustworthy entity in an electronic communication. Communications purporting to be from well known and/or reputable financial or other institutions providing on-line operations (such as online banks, online auction sites, etc.) may be used to lure the unsuspecting to a fraudulent web site. An e-mail, for example, may include a link to a fraudulent web site designed to obtain sensitive information.

Phishing is discussed, for example, in U.S. Patent Pub. No. 20070192855; U.S. Patent Pub. No. 20070094500; U.S. Patent Pub. No. 20070039038; U.S. Patent Pub. No. 20070033639; U.S. Patent Pub. No. 20060168066; U.S. Patent Pub. No. 20060123478; U.S. Patent Pub. No. 20060123464; U.S. Patent Pub. No. 20060101120; and U.S. Patent Pub. No. 20060080735. The disclosures of each of the above referenced U.S. Patent Publications are hereby incorporated herein in their entirety by reference.

### SUMMARY

According to some embodiments of the present invention, methods of providing reputation information for a remote device may include receiving a name for the remote device from a client device. Responsive to receiving the name for the remote device, the name may be translated into an Internet Protocol (IP) address for the remote device. Also responsive to receiving the name for the remote device, reputation information for the remote device may be provided. The IP address and the reputation information may then be transmitted to the client device.

More particularly, the name may be received at a name server, and the IP address and the reputation information may be transmitted from the name server to the client device. The name may include a host name, domain name, and/or a Uniform Resource Locator (URL).

Providing the reputation information may include determining if the name is identified in a policy list. The policy list may include a blacklist and/or a whitelist. The name may be received at a name server, and the IP address and the reputation information may be transmitted from the name server to the client device, and the policy list may be stored at the name server and/or at a separate policy server remote from the name server.

The reputation information may include information providing a status of the remote device as a suspected phishing device. In addition, the reputation information may include classification information for the remote device, and transmitting the reputation information may include transmitting the classification information to the client device. Providing the reputation information may include comparing the name with a policy list and determining if the policy list includes a full match with the name and/or determining if the policy list includes a partial match with the name.

Providing the reputation information may include comparing the name and/or the IP address with entries in a policy list. The name, the IP address, and the reputation information may be stored in a memory for a time interval, and the name, the IP address, and the reputation information may be expired from the memory after expiration of the time interval. Moreover, the IP address and the reputation information may be transmitted to the client device in a same IP packet.

According to additional embodiments of the present invention, a method of accessing a remote device from a client device may include transmitting a name for the remote device from the client device to a name server, and an IP address and reputation information for the remote device corresponding to the name from the name server may be received from the name server. A client policy may be applied based on the reputation information, and communication may be established with the remote device consistent with applying the client policy based on the reputation information and using the IP address.

Establishing communication with the remote device consistent with applying the client policy based on the reputation information may include denying communication with the remote device if the reputation information indicates that the remote device is suspect. For example, communication may be denied if the reputation information indicates that the remote device is suspected as a phishing device. Denying communication with the remote device may include alerting a user of the client device that the remote device is suspect, and allowing communication responsive to a user override.

Establishing communication with the remote device consistent with applying the client policy based on the reputation information may include allowing communication with the remote device if the reputation information indicates that the remote device is not suspect. The name may include a host name, domain name, and/or a Uniforn Resource Locator (URL), and the reputation information may include information providing a status of the remote device as a suspected phishing device.

In addition, the name, the IP address, and the reputation information may be stored in memory of the client device for a time interval, and after expiration of the time interval, the name, the IP address, and the reputation information may be expired from the memory of the client device. Moreover, the IP address and the reputation information may be received at the client device from the name server in a same IP packet.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Non-limiting and non-exhaustive embodiments of the present invention will be described with reference to the following figures, wherein like reference numerals refer to like parts throughout the various figures unless otherwise specified. In the figures:

FIG. 1 is a block diagram illustrating an internetwork of devices according to some embodiments of the present invention.

FIG. 2 is a block diagram of a client device according to some embodiments of the present invention.

FIG. 3 is a block diagram of a name server according to some embodiments of the present invention.

FIG. 4 is a flow chart illustrating operations of providing an IP address and reputation information according to some embodiments of the present invention.

FIG. 5 is a flow chart illustrating operations of expiring an IP address and reputation information from memory of a name server according to some embodiments of the present invention.

FIG. 6 is a flow chart illustrating operations of establishing communications with a remote device according to some embodiments of the present invention.

FIG. 7 is a flow chart illustrating operations of denying and/or allowing communication with a remote device according to some embodiments of the present invention.

FIG. 8 is a flow illustrating operations of expiring an IP address and reputation information from memory of a client device according to some embodiments of the present invention.

FIG. 9 illustrates a DNS RDATA record including reputation information according to some embodiments of the present invention.

FIGS. 10 and 11 illustrate interpretations of reputation information according to some embodiments of the present invention.

FIG. 12 illustrates a syntax for a configuration entry according to some embodiments of the present invention.

FIG. 13 illustrates a configuration file for a name server according to some embodiments of the present invention.

FIG. 14 illustrates a DNS client request sent by a client device to a name server according to some embodiments of the present invention.

FIG. 15 illustrates a DNS response message returned by a name server to a client device responsive to the request of FIG. 14 according to some embodiments of the present invention.

FIG. 16 illustrates a DNS client request sent by a client device to a name server according to some embodiments of the present invention.

FIG. 17 illustrates a DNS response message returned by a name server to a client responsive to the request of FIG. 15 according to some embodiments of the present invention.

### DETAILED DESCRIPTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first client device could be termed a second client device, and, similarly, a second client device could be termed a first client device without departing from the teachings of the disclosure.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as methods, computing systems, and/or computer program products. Accordingly, embodiments of the present invention may take the form of an entirely hardware embodiment, an entirely software embodiment (including firmware, resident software, micro-code, etc.) or an embodiment combining software and hardware aspects. Furthermore, embodiments of the present invention may take the form of a computer program product on a computer-usable storage medium having computer-usable program code embodied in the medium. Any Suitable computer readable medium may be utilized including hard disks, CD-ROMs, optical storage devices, a transmission media such as those supporting the Internet or an intranet, or magnetic storage devices. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable maimer, if necessary, and then stored in a computer memory.

Computer program code for carrying out operations of embodiments of the present invention may be written, for example, in an object oriented programming language such as JAVA®, Smalltalk, and/or C++. However, the computer program code for carrying out operations of embodiments of the present invention may also be written in conventional procedural programming languages, such as the “C” programming language or in a visually oriented programming environment, such as VisualBasic.

The invention is described in part below with reference to block diagrams of methods, systems and/or computer program products according to embodiments of the invention. It will be understood that each block of the illustrations, and combinations of blocks, can be implemented by computer program instructions. These computer program instructions may be provided to a processor of a general purpose computer, special purpose computer, or other programmable computing apparatus to produce a machine, such that the instructions, which execute via the processor of the computer or other programmable computing apparatus, create means for implementing the functions/acts specified in the block or blocks.

These computer program instructions may also be stored in a computer-readable memory that can direct a computer or other programmable computing apparatus to function in a particular manner, such that the instructions stored in the computer-readable memory produce an article of manufacture including instruction means which implement the function/act specified in the block or blocks.

The computer program instructions may also be loaded onto a computer or other programmable computing apparatus to cause a series of operational steps to be performed on the computer or other programmable apparatus to produce a computer implemented process such that the instructions which execute on the computer or other programmable apparatus provide steps for implementing the functions/acts specified in the block or blocks.

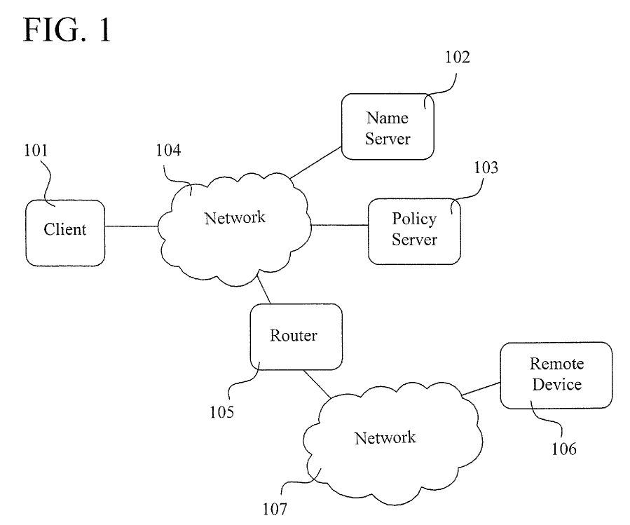

FIG. 1 is a block diagram illustrating an internetwork of devices, according to some embodiments of the present invention. The internetwork of devices may include one or more client devices 101 requesting name translation from a name server 102, such as a Domain Name Server (DNS). For example, the one or more client devices 101 may request translation of a name of a remote device 106 from the name server 102. The remote device name sent by client 101 to name server 102 may be a host name, a domain name, and/or a Uniform Resource Locator (URL), and/or sub-portions thereof.

As shown in FIG. 1, client device 101 may be coupled to name server 102 and router 105 over a network 140, such as a local area network (LAN), and/or a wide area network, such as the Internet. Moreover, client device 101 may be coupled to remote device 106 through network 104, router 105, and network 107, such as the Internet. In addition, name server 102 may be coupled to a remote policy server 103 through network 104, or a separate policy server may be omitted if functionality thereof is implemented at name server 102. While one client device 101, one name server 102, one remote device 106, and one router 105 are shown in FIG. 1 for ease of illustration, it will be understood that any number of client devices, name servers, remote devices, and routers may be provided according to embodiments of the present invention. Moreover, each of networks 104 and 107 may be a single network or any number of sub-networks, and/or networks 104 and 107 may represent different portions of a same network.

According to some embodiments of the present invention, name server 102 may provide reputation status information about a remote device 106 corresponding to a name of the remote device being translated, and/or name server 102 may provide classification status information about the remote device 106. The reputation status information may include information providing a status of the remote device as a suspected phishing device. For example, responsive to a request including a name of remote device 106 from the client 101, the name server 102 may return reputation status information and/or classification status information regarding remote device 106. The reputation status information and/or classification status information may be returned in one or more DNS (Domain Name Server) RDATA (Read Data) records, for example, using a Domain Reputation and IP (Internet Protocol) Number Classification (DRIC) record defined according to embodiments of the present invention. As used herein, the term reputation information may include reputation status information and/or classification status information.

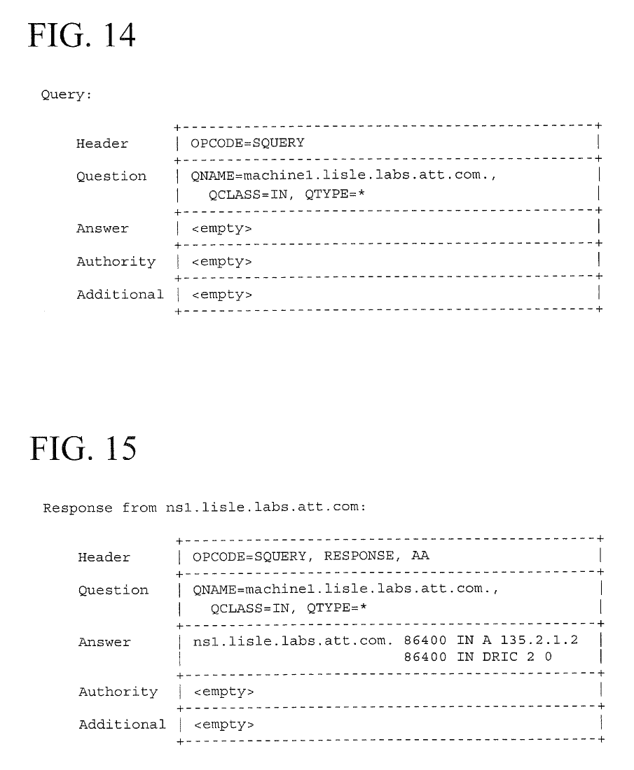

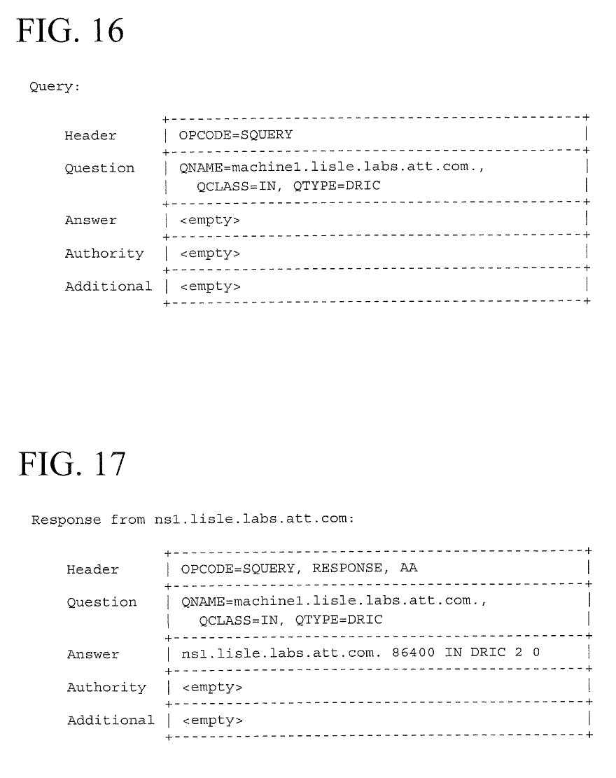

In addition to the reputation status information and/or classification status information returned to the client device 101, the response may also include one or more IP addresses for the remote device. For example, an IP address(es) may be returned within one or more DNS “A” RDATA records of a DNS response. Both translated IP address information and reputation status and/or classification status information may be returned to client device 101 within a same response, responsive to a wildcarded DNS query. For example, such a wildcarded query may be formed by setting a QTYPE field of the DNS request message to an asterisk (“*”) as discussed in greater detail below with respect to FIGS. 14 and 15. Alternatively, a more specific request may be sent by client 101 to name server 102 to specifically query reputation status information and/or classification status information of remote device 106. For example, a specific query may be denoted by setting a QTYPE field of the DNS request message to “DRIC” as discussed in greater detail below with respect to FIGS. 16 and 17. Responsive to that more specific query, name server 102 may return a response including the reputation status information and/or classification status information and may not return translated IP address information. More particularly, client 101 may transmit a wildcarded DNS query to name server 102 to reduce a number of network messaging round-trip times, thereby reducing network traffic, reducing messaging round trip delays, and/or reducing user perceived latency. The name server 102 may transmit the response within a single IP packet, so as to further reduce network traffic, reduce messaging round trip delays, and/or reduce user perceived latency. Notwithstanding the foregoing, embodiments of the present invention may allow the client 101 to query the name server 102 for the reputation status information and/or classification status information (DRIC record) of a remote device 106 independently of the IP address (A record) information.

The name server 102, for example, may be a Domain Name Server (DNS), a NetBIOS Name Server, a WINS server, and/or other name server. For example, the name server may be implemented as a Domain Name Server in compliance with RFC1034 and/or RFC1035, and/or the name server may be implemented in compliance with further extensions to DNS, including secured DNS extensions such as DNSSEC (as described by RFC2535) and/or DNSSEC-bis (as described by RFCs 4033 to 4035)), dynamic DNS (as described by RFC2136), and/or other DNS extensions. The disclosures of each of the Requests For Comments (RFCs) noted above are hereby incorporated herein in their entirety by reference.

Client device 101 may be coupled to remote device 106 through network 104, router 105, and network 107 as shown in FIG. 1. While shown coupled to remote device 106 via a single router 105 and networks 104 and 107, client device 101 and remote device 106 may be coupled through a plurality of local area networks, a plurality of remote data networks, and/or a plurality of routers, or remote device 106 and client device 101 may be coupled to a same local network, such as network 104. Moreover, there may be many such remote devices 106 coupled at different locations within the internetwork. The internetwork of devices may include the Internet, an intranet, a combination of both, VPN tunnels, and/or other network configurations. Networking protocols of the internetwork may include Internet Protocol (IP) protocols such as Internet Protocol version 4 (IPv4), Internet Protocol version 6 (IPv6), and/or other networking protocols.

According to some embodiments of the present invention, responsive to receiving a name from client device 101, name server 102 may obtain reputation status information and/or classification status information by comparing the name with a policy list and determining whether the policy list includes a full and/or partial match with the name. Other embodiments of the present invention may obtain reputation status information and/or classification status information by comparing a translated IP address (corresponding to the name received from client device 101) with the policy list and determining whether the policy list includes a full and/or partial match of the IP address. The policy list may be implemented as a blacklist, a whitelist, a combination of both, and/or another data structure.

The policy list may be stored, maintained, and administered within the name server 102. Within such environments, policy server 103 may be unnecessary. Stated in other words, functionality of policy server 103 may be implemented in the name server 102 so that a separate policy server is not required. According to other embodiments of the present invention, a policy server 103 (separate from name server 102) may store reputation status information and/or classification status information regarding remote devices, domains, and/or URLs. Accordingly, name server 102 may query the separate policy server 103 for reputation status information and/or classification status information, or alternatively, the policy server 103 may push the reputation status information and/or classification status information to the name server 102. Communication between the DNS server and the policy server may be implemented, for example, using a protocol such as COPS (Common Open Policy Service), using a proprietary protocol and/or messaging format and/or mechanism, and/or with remote function calls. The policy server 103 may be administered by the same organization administering the name server 102, or may alternatively be administered by a different organization, such as a trusted third party. To further increase system reliability and uptime, the name server 102 may be implemented as a redundant plurality of name servers and/or the policy server 103 may be implemented as a redundant plurality of policy servers.

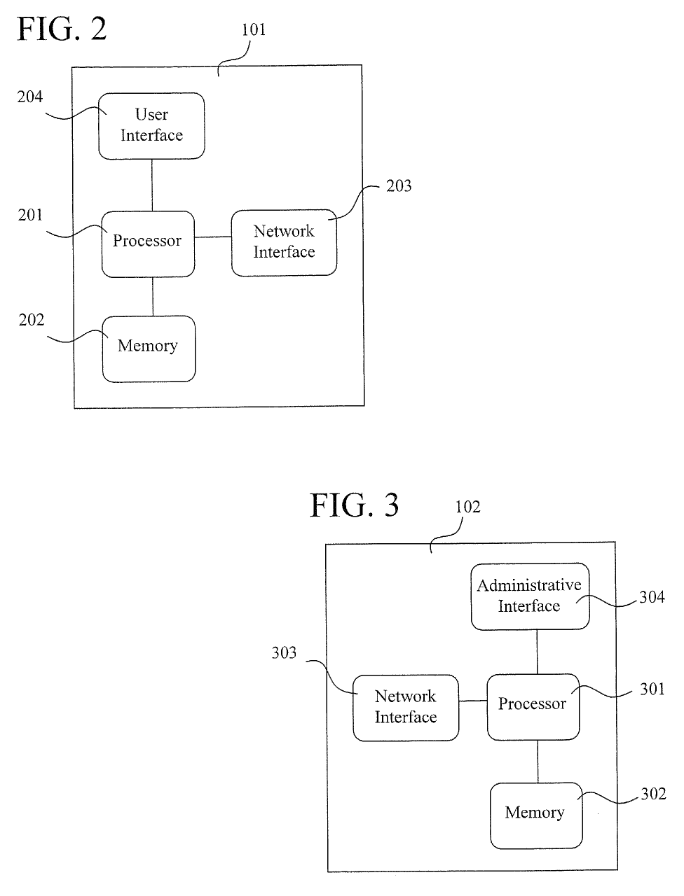

As shown in FIG. 2, client device 101 may include processor 201, memory 202, network interface 203 configured to provide coupling with data network 104, and user interface 204. Moreover, processor 201 may be configured to execute a plurality of applications (such as web browser applications, e-mail applications, and/or other applications) stored in memory 202. The user interface 204 may be implemented as a command line interface, a graphical user interface, a touch-screen interface, speech-driven interface, and/or other user interface. For example, the user interface 204 may include a keyboard, a keypad, a mouse, a display, a microphone, a speaker, a joystick, a touch sensitive display, etc.

As shown in FIG. 3, name server 102 may include processor 301, memory 302, networking interface 303 configured to provide coupling with data network 104, and administrative interface 304. Administrative interface 304 may be implemented as a command line interface, a graphical user interface, and/or other user interface.

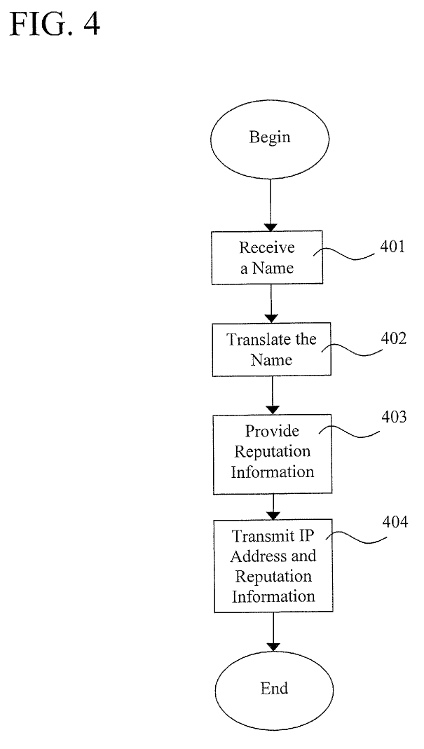

FIG. 4 is a flow chart illustrating operations of providing an IP address and reputation information for a remote device 106 from name server 102 to client device 101 according to some embodiments of the present invention. Upon receipt of a request from client device 101 including a name of remote device 106 (block 401), name server 102 translates the name into an IP address (block 402). This translation may be performed using local address translation tables (in memory 302), through recursive queries to other name servers within and/or outside the internetwork, and/or using unexpired translation information (in a cache portion of memory 302) that had been cached during past queries. Using the remote device name and/or translated IP address as a lookup key, name server 102 may consult a policy list to determine whether the name and/or translated IP address matches one or more reputation status information entries of the policy list (block 403). In addition, the name server 102 may consult the policy list to determine whether the name and/or translated IP address matches one or more classification status information entries of the policy list. The consulted policy list may be stored at name server 102 (in memory 302) and/or separately stored at a separate policy server 103 remote from the name server 102.

A matching entry within the policy list may be found based on a full match of the name or IP address. For example, an entry within the policy list may match all devices within the blackhole.org domain, and such a range may be identified as “*.blackhole.org”. As another example, an entry within the policy list might match all devices in all networks that have a certain machine name prefix, and such a range may be identified as “blackhole*.*”. In addition, a matching entry within the policy list may be found using a partial match of the name or IP address. For example, an entry within the policy list might match all addresses within the 169.254.0.0 network, and such a range may be identified as “169.254.0.0/255.255.0.0”.

Reputation status information and/or classification status information may be used to identify the remote device as a suspected phishing device. Reputation status information may include a designation of a machine as being a blacklisted machine and/or reputation status information may include a designation of a machine as being within a blacklisted domain. Classification status information may include a designation of a machine as being a zombie machine or as having a zombie IP address. Classification status information may further include a designation of a machine as having a static or dynamic IP address. The classification information may further include a designation of the machine as being a business device or a home device. These classifications are provided by way of example, and additional and/or other classifications may be provided.

Reputation status information may be represented using any one of a plurality of syntaxes. For example, reputation status information may be represented using a bitmask, a byte, an integer, an ASCII string, and/or combination(s) of such structures. Similarly, classification status information may be represented by any of a variety of syntaxes, such as a bitmask, a byte, an integer, an ASCII string, and/or combination(s) of such structures.

Name server 102 transmits the translated IP address and any matching reputation information (including any matching reputation status information and/or classification status information) to client device 101 (block 404). The translated IP address, reputation status information, and classification status information may be transmitted from the name server 102 to the client device 101 within a same IP packet to reduce network traffic.

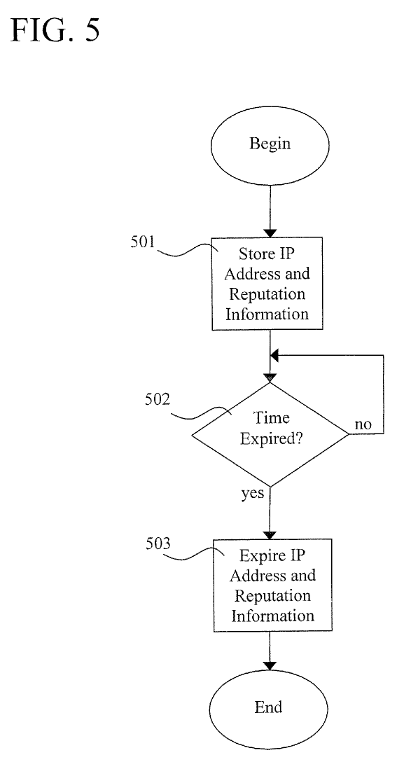

FIG. 5 is a flow chart illustrating caching operations that may be performed by name server 102 according to some embodiments of the invention if reputation information is obtained from a separate policy server 103 or from another name server. Upon receiving reputation information from another source (such as policy server 103 or from another name server), name server 102 may store the IP address and associated reputation information (including reputation status information and/or classification status information) in a cache portion of memory 302 (block 501). Such information may be pulled (and/or polled) by name server 102 from policy server 103, or alternatively, such information may be pushed to name server 102 by policy server 103. Such information may be pushed to the name server 102 by the policy server 103 to reduce delay of name server 102 processing and responding to a request from client device 101. Upon storing an entry (including the name and associated IP address and reputation information) in memory 302, the name server 102 may start an expiration timer. The expiration timer may have an administratively configurable default time-to-live (TTL) value for all records and/or may be further administratively configured with a different time-to-live (TTL) value for each record. Upon timeout of the timer (block 502) for the record, the name and associated IP address and reputation information for the record will be expired from memory 302 of name server 102 (block 503). Operations of FIG. 5 may be implemented using a cache portion of memory 302 and a benefit of using operations of FIG. 5 may be to reduce network traffic and/or per-transaction latency. For example, name server 102 may respond to subsequent requests for translations of the same name and associated reputation information (from the same or a different client device) without requesting information from a remote policy server or from another name server.

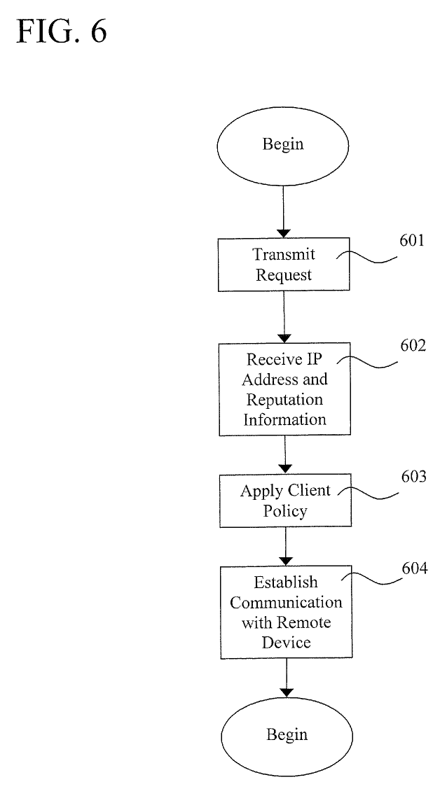

FIG. 6 is a flow chart illustrating operations of client device 101 establishing communication with remote device 106 using an IP address and reputation information provided by name server 102. In preparation to communicate with remote device 106, client device 101 may send a request to name server 102 including a name of the remote device 106 (block 601). For example, responsive to a user of client device 101 browsing to a web site hosted by remote device 106, the web browser application running on processor 201 of client device 101 may transmit a request for an IP address for the remote device 106 to the name server 102. As discussed above with respect to FIG. 4, name server 102 may respond by transmitting an IP address and reputation information corresponding to the name of remote device 106. Upon receiving the response from the name server 102 (block 602), the client device 101 may extract the translated IP address and reputation information from the response, and client device 101 may apply a client policy (block 603) using the received reputation information.

Client device 101 may establish communication with remote device 106 consistent with applying the client policy based on the reputation information (including reputation status information and/or classification status information) and using the received IP address remote device 106 (block 604). The translated IP address and reputation information may be received from name server 102 in a same IP packet to reduce network traffic. Alternatively, the translated IP address and reputation information may be received as separate responses from name server arriving in separate IP packets. The reputation information may include reputation status information and classification status information for the remote device 106, and both reputation status information and classification status information may be received within the same response (e.g., within the same IP packet). In some embodiments of the invention, the translated IP address may be received within an A record of a DNS response and reputation information may be received within a DRIC record of the same DNS response. Client device 101 may routinely perform operations of FIG. 6 in preparation for each communication with a remote device.

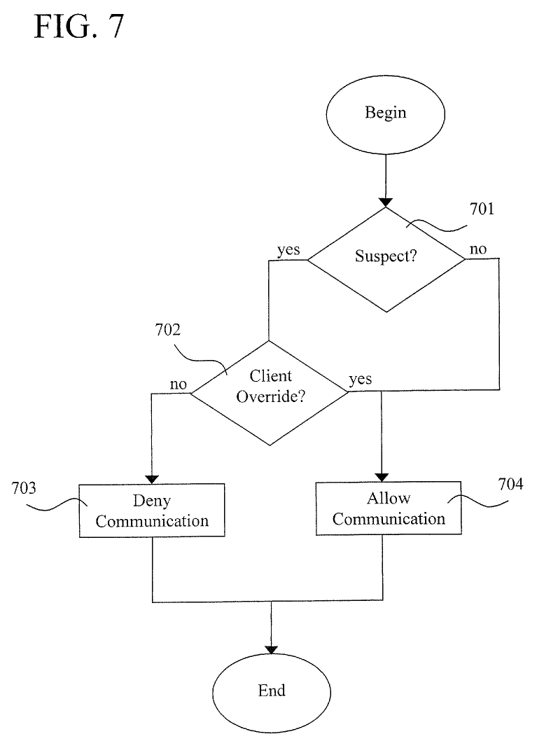

Communication may be established with remote device 106 consistent with applying the client policy based on the received reputation information and using the IP address (block 604) as shown in FIG. 7. Block 604 of FIG. 6 may include determining whether the remote device name is suspect (block 701) based on the reputation information received from name server 102 (as shown in FIG. 7). If the remote device name is suspect, client device 101 may deny communications with remote device 106 (block 703) unless a user override is detected by client device 101 (block 702). If a user override is detected by client device 101 (block 702), communications with remote device 106 may be allowed (block 704).

For example, if the received reputation information indicates that remote device 106 may be suspect, client device 101 may present a pop-up warning/alert on a graphical user interface of client device 101 before allowing communications, and a user of client device 101 may override the denied communication by providing an appropriate input responsive to the warning. Alternatively, user override preferences may be stored as client policy within memory 202 of the client device 101 by a user or an administrative user of client device 101. For example, user identified names of remote devices may be saved as a whitelist in memory 202 of client device 101 so that client override is automatic for names included in the whitelist.

Client device 101 may thus alert a user of the client device 101 that the remote device 106 is suspect, and allow communication responsive to a user override (block 704). The alerting may be audible, visual, or otherwise sensory so as to solicit the attention of a user of client device 101. The alerting may additionally include logging the name and reputation information within an administrative log. If the reputation information indicates that the remote device 106 is not suspect or allowed by a client override (blocks 701 and 702), communication between client device and remote device 106 may be allowed (block 704).

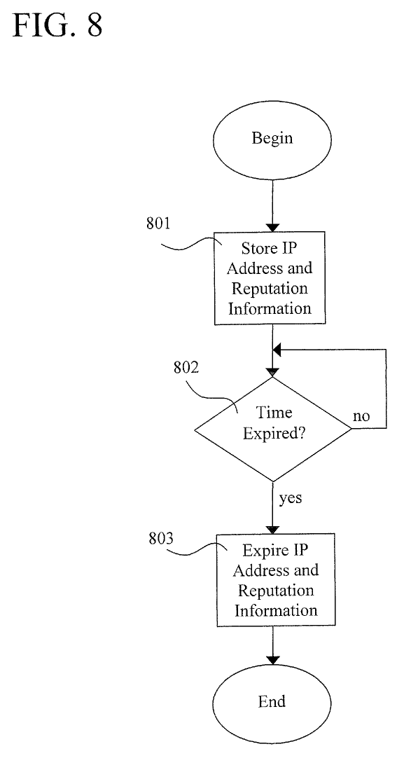

FIG. 8 is a flow chart illustrating caching operations that may be performed by client device 101. Upon receiving IP address and reputation information (including reputation status information and/or classification status information) from name server 102, the client device 101 may store the name and associated IP address and reputation information as a record in a cache portion of memory 202 (block 801). Upon storing the name and associated IP address and reputation information in memory 202, client device 101 may start an associated expiration timer. The timer may be set using a default time-to-live (TTL) value, using a TTL value determined by a user for the particular record, or using a TTL value received from the name server 102. Alternatively, the timer may be set using an administratively configurable TTL value. Upon timeout of the timer (block 802), the associated record including the name and associated IP address and reputation information will be expired from memory 202 of the client device 101 (block 803). This caching may be implemented in a cache portion of memory 202 and network traffic may be reduced by reducing redundant queries to name server 102 and to application responsiveness may be increased as perceived by a client device user.

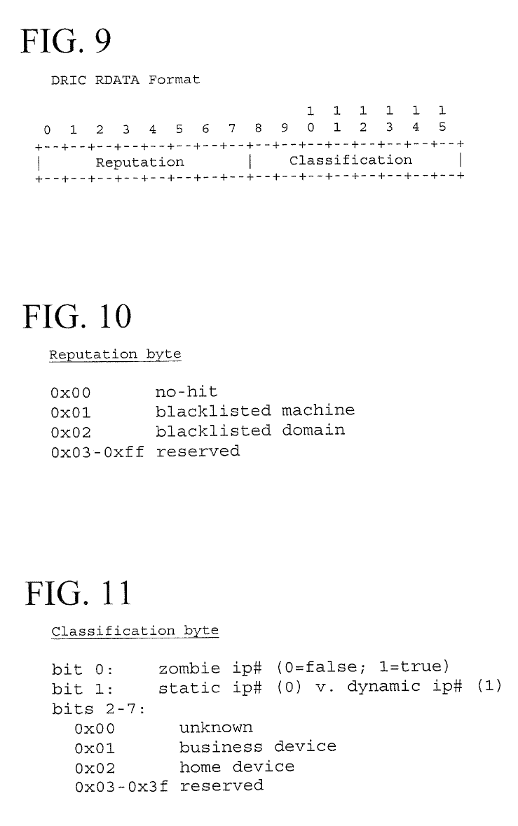

FIG. 9 illustrates an example of a DNS (Domain Name Server) RDATA (Read Data) record including reputation information (including reputation status information and classification status information), according to some embodiments of the present invention. As shown, one byte of the record may designate reputation status information and another byte of the same record may designate classification status information. Such a record may be designated as a Domain Reputation and IP Number Classification (DRIC) record according to some embodiments of the present invention, and may be used within an RDATA field of a DNS message. Other representations of reputation status information and/or classification status information may be used according to other embodiments of the present invention such as a multi-byte bitmask, a multi-byte hexadecimal value (such as an integer), a sequence of characters (such as an ASCII string), or a combination of such structures. For example, reputation information may be represented by a character string, and ASCII string values such as “no-hit”, “blacklisted machine”, and “blacklisted domain” could be used. Such character string values may be concatenated in sequence to concurrently provide multiple designations.

FIGS. 10 and 11 illustrate examples of values for reputation status information (FIG. 10) and classification status information (FIG. 11) corresponding to FIG. 9. It is noted that these figures are provided by way of example and that other representations and/or other value assignments may be used, provided that client device 101 and name server 102 use the same representations and interpretations of assigned values.

As shown in FIG. 10, a reputation byte value of 0x00 may indicate that there is no reason to suspect that the remote device identified by the name is a phishing device. A reputation byte value of 0x01 may indicate that the remote device has been identified on a blacklist of suspected phishing devices. A reputation byte value of 0x02 may indicate that the remote device belongs to a domain that has been identified on a blacklist of suspected phishing domains. Reputation byte values 0x03 to 0xff may be reserved for future use.

As shown in FIG. 11, a bit 0 of classification byte may indicate whether a remote device is suspected of being a zombie (bit 0=1) or not (bit 0=0). A bit 1 may indicate whether a remote device is a static device (bit 1=0) or a dynamic device (bit 1=1). Other bits of the classification byte may indicate whether the remote device is known/unknown and whether the remote device is a business device or a home device, and still other bits of the classification byte may be reserved for future use.

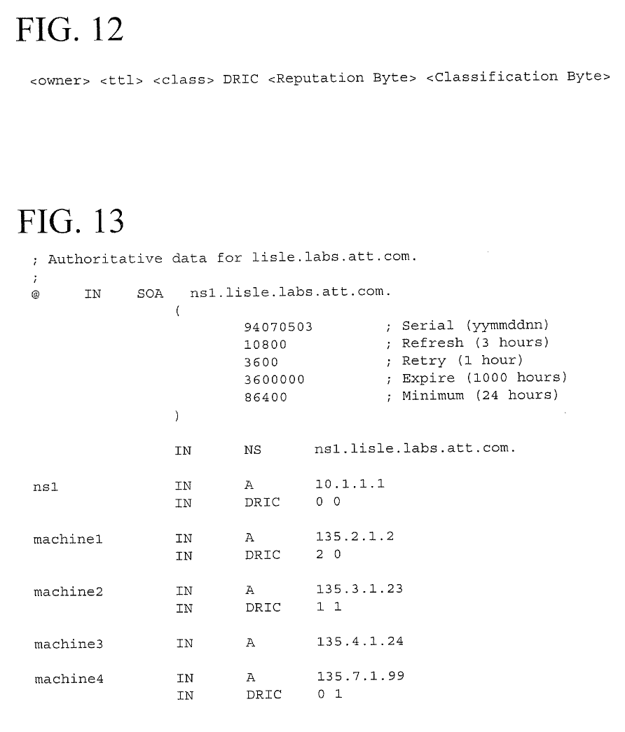

FIG. 12 illustrates a syntax of fields of a name server configuration entry for a DRIC record according to some embodiments of the present invention provided in a format consistent with Request For Comments No. RFC-1034, “Domain Names-Concepts And Facilities,” November, 1987, the disclosure of which is hereby incorporated herein in its entirety by reference. More particularly, <owner> represents a domain name where the resource record (RR) is found (e.g., machine1, machine2, machine3, and machine4 of FIG. 13), <ttl > represents a time to live of the resource record (not shown in FIG. 13), <class> represents a protocol family or instance of a protocol (e.g., IN for the Internet system or CH for the chaos system), DRIC identifies a record providing reputation information according to embodiments of the present invention, and <Reputation Byte> and <Classification Byte> identify fields of a DRIC record according to embodiments of the present invention. For an A record, the identification DRIC may be replaced by the identification A, and the <Reputation Byte> and <Classification Byte> may be replaced by an IP address.

FIG. 13 illustrates an example of a configuration file for name server 102, according to some embodiments of the present invention wherein a DNS server is used as name server 102. More particularly, the configuration file of FIG. 13 may be provided for an authoritative name server (identified as nsl.lisle.labs.att.com) for the domain lisle.labs.att.com, and the configuration file of FIG. 13 may include an A record and/or a DRIC record for a plurality of devices of the domain (e.g., machine1, machine2, machine3, machine4, etc.) With respect to machine1, for example, the A record may include the IP address 135.2.1.2, and the DRIC record may include the reputation byte 2 and the classification byte 0. With respect to machine2, the A record may include the IP address 135.3.1.23, and the DRIC record may include the reputation byte 1 and the classification byte 1. With respect to machine, the A record may include the IP address 135.4.1.24, and a DRIC record may be omitted. With respect to machine4, the A record may include the IP address 135.7.1.99, and the DRIC record may include the reputation byte 9 and the classification byte 1. The information included in the reputation and classification bytes may be collectively referred to as reputation information.

According to embodiments illustrated in FIGS. 9-12, the configuration file of FIG. 13 may provide the configuration entries including the following reputation information: for name server nsl.lisle.labs.att.com identified as not suspected as a phishing device; for machine1.lisle.labs.att.com which is identified as being from a suspected phishing domain; for machine2.lisle.att.com identified as a blacklisted machine and as a business device; for machine3 identified as not suspected as a phishing device; and for machine4.lisle.att.com identified as a business device and as not suspected as a phishing device.

According to some embodiments of the present invention, a single request from the client device 101 may be transmitted to name server 102 requesting both an IP address and reputation information for remote device 106 (in a single IP packet). Accordingly, name server 102 may respond with a single response including the requested IP address and reputation information (in a single IP packet). By way of example, FIG. 14 shows a representation of a DNS request message including a wildcarded query (“QTYPE=*”) sent from client device 101 to name server 102 (“nsl.lisle.labs.att.com”) regarding remote device 106 named “machine1.lisle.labs.att.com”. Similarly, FIG. 15 shows a representation of a DNS response message as may be returned by name server 102 configured according to the configuration file illustrated in FIG. 13 in response to the request of FIG. 14. Accordingly, the response of FIG. 15 may include both an A record identifying an IP address (135.2.1.2) and a DRIC record identifying reputation information (e.g., a reputation byte of 2 and a classification byte of 0) for remote device 106.

According to other embodiments of the present invention, a request from client device 101 may be transmitted to name server 102 requesting only reputation information from remote device 106 (and not requesting an IP address). Accordingly, name server 102 may return a response including the requested reputation information (without providing an IP address). A separate request for an IP address of remote device 106 may be transmitted from client device 101 (e.g., an A record request), and a separate response including the IP address may be returned by name server 102 (e.g., a DNS A record response). By way of example, FIG. 16 shows a representation of a DNS request message including a DRIC query sent from a client device 101 to a name server 102 (“nsl.lisle.labs.att.com”) regarding remote machine 106 named “machine1.lisle.labs.att.com”. Similarly, FIG. 17 shows a representation of a DNS response message as may be returned by name server 102 configured according to the configuration file illustrated by FIG. 13 in response to the request of FIG. 16. Accordingly, the response of FIG. 17 may include a DRIC record identifying reputation information (e.g., a reputation byte of 2 and a classification byte of 0) for remote device 106, without providing an IP address.

By combining name translation with providing reputation information for a remote device at a name server, a time to establish communication between a client device and the remote device may be reduced and/or network traffic may be reduced. Moreover, by maintaining reputation information for suspect devices (e.g., remote devices suspected of operating as phishing devices) at a name server and/or at a policy server accessed by a name server, memory consumed at a client device to identify phishing devices (and/or other suspect device) may be reduced, and client device resources required to update phishing device identifications may be reduced. While phishing is discussed by way of example, reputation information according to embodiments of the present invention may be used to identify remote devices suspected of other potentially harmful activities.

In the drawings and specification, there have been disclosed embodiments of the invention. However, many variations and modifications can be made to these embodiments without departing from the principles of the present invention. All such variations and modifications are intended to be included herein within the scope of the present invention, as set forth in the following claims.

That which is claimed is:

1. A method of providing reputation information for a remote device, the method comprising:
receiving a name for the remote device from a client device;
responsive to receiving the name for the remote device, translating the name into an Internet Protocol (IP) address for the remote device;
responsive to receiving the name for the remote device, providing reputation information for the remote device; and
transmitting the IP address and the reputation information to the client device.

2. A method according to claim 1 wherein receiving the name comprises receiving the name at a name server, and wherein transmitting the IP address and the reputation information comprises transmitting the IP address and the reputation information from the name server to the client device.

3. A method according to claim 1 wherein the name comprises a host name, domain name, and/or a Uniform Resource Locator (URL).

4. A method according to claim 1 wherein providing the reputation information comprises determining if the name is identified in a policy list.

5. A method according to claim 4 wherein the policy list comprises a blacklist and/or a whitelist.

6. A method according to claim 4 wherein receiving the name comprises receiving the name at a name server, and wherein transmitting the IP address and the reputation information comprises transmitting the IP address and the reputation information from the name server to the client device, and wherein the policy list is stored at the name server and/or at a separate policy server remote from the name server.

7. A method according to claim 1 wherein the reputation information comprises information providing a status of the remote device as a suspected phishing device.

8. A method according to claim 1 wherein providing reputation information comprises providing classification information for the remote device, and wherein transmitting the reputation information comprises transmitting the classification information to the client device.

9. A method according to claim 1 wherein providing the reputation information comprises comparing the name with a policy list and determining if the policy list includes a full match with the name and/or determining if the policy list includes a partial match with the name.

10. A method according to claim 1 wherein providing the reputation information comprises comparing the name and/or the IP address with entries in a policy list.

11. A method according to claim 10 further comprising:
storing the name, the IP address, and the reputation information in a memory for a time interval; and
after expiration of the time interval, expiring the name, the IP address, and the reputation information from the memory.

12. A method according to claim 1 wherein transmitting comprises transmitting the IP address and the reputation information to the client device in a same IP packet.

13. A method of accessing a remote device from a client device, the method comprising:
transmitting a name for the remote device from the client device to a name server;
receiving at the client device an IP address for the remote device corresponding to the name from the name server;
receiving reputation information for the remote device from the name server;
applying a client policy based on the reputation information; and
establishing communication with the remote device consistent with applying the client policy based on the reputation information and using the IP address.

14. A method according to claim 13 wherein establishing communication with the remote device consistent with applying the client policy based on the reputation information comprises denying communication with the remote device if the reputation information indicates that the remote device is suspect.

15. A method according to claim 14 wherein denying communication with the remote device comprises alerting a user of the client device that the remote device is suspect, and allowing communication responsive to a user override.

16. A method according to claim 13 wherein establishing communication with the remote device consistent with applying the client policy based on the reputation information comprises allowing communication with the remote device if the reputation information indicates that the remote device is not suspect.

17. A method according to claim 13 wherein the name comprises a host name, domain name, and/or a Uniform Resource Locator (URL).

18. A method according to claim 13 wherein the reputation information comprises information providing a status of the remote device as a suspected phishing device.

19. A method according to claim 13 further comprising:
storing the name, the IP address, and the reputation information in memory of the client device for a time interval; and
after expiration of the time interval, expiring the name, the IP address, and the reputation information from the memory of the client device.

20. A method according to claim 13 wherein receiving comprises receiving the IP address and the reputation information at the client device from the name server in a same IP packet.
